(19) United States
(12) Patent Application Publication
(10) Pub. No.: US 2009/0261777 A1
(43) Pub. Date: Oct. 22, 2009

(54) SOLAR PANEL CHARGING DISPLAY DEVICE AND METHOD

(75) Inventors: Mingchuan Chen, Banqiao City (TW); Chunhorn Kuo, Taipei City (TW)

Correspondence Address: KENING LI;PINSENT MASONS LLP, c/o FOUNTAIN LAW GROUP, INC, 18201 Von Karman Avenue, Suite 960, Irvine, CA, 92612, US

(73) Assignee: TSANN KUEN (ZHANGZHOU) ENTERPRISE CO., LTD., Zhangzhou (CN)

(21) Appl. No.: 12/424,763

(22) Filed: Apr. 16, 2009

(30) Foreign Application Priority Data
Apr. 16, 2008 (TW) 097113813

(51) Int. Cl. H01M 10/46

(52) U.S. Cl. 320/101

(57) ABSTRACT

A solar panel charging display device comprises: a solar panel capable of transforming solar energy into electrical energy; one storage module connected to the solar panel and storing the electrical energy produced by the solar panel; one measurement module connected to the solar panel and the storage module, and capable of generating an electrical signal which is an indication of the electric energy the solar panel generates and transfers to the storage module; and one display module connected to the measurement module and dynamically displaying the voltage or current. Using the display device, the user would easily determine the relationship between the positions or angle of the solar pane and the electrical energy is generating and re-arrange the solar panel accordingly for optimal performance. A method of use of the solar panel charging display device is also provided.

### CROSS REFERENCES TO RELATED APPLICATIONS

This application claims priority to Taiwan Patent Application No. 097113813, filed on Apr. 16, 2008, the entire disclosure of which is incorporated herein by reference.

### FIELD OF THE INVENTION

The present invention generally relates to a solar panel charging device and method of use thereof, more particularly to a solar panel charging device with a display module.

### BACKGROUND OF THE INVENTION

With decreased output, the price of oil has been increasing, leading to intensified research into other sources of energy to replace oil. Among the alternative energy sources, solar energy has many advantages such as no pollution. Solar energy does not discharge any exhaust gas during the transformation process; and it can be easily gained.

Solar energy is commonly transformed into electrical energy by a solar panel, then the electrical energy is transported to other electrical devices for use. The power of the electrical energy generated by the solar panel depends on the intensity of illumination received by the surface of the solar panel, i.e. the higher intensity of illumination is received by the solar panel, the more electrical power will be generated. So in solar panel configuration, the angle and positioning of the solar panel relative to the solar radiation are key factors affecting both the intensity of illumination, and the electrical energy generated by the solar panel.

However, traditional solar panels or appliances (e.g. solar batteries, solar chargers) do not have a display device for displaying the intensity of illumination. The users cannot know whether the intensity of illumination received by the solar panel is enough or not, and the solar panels are set just only by estimating the intensity of illumination subjectively, so usually the solar panel cannot generate electrical energy optimally.

### SUMMARY OF THE INVENTION

The present invention is to provide a solar panel charging display device and a method of use thereof, therefore users will know the best positions or angles for arranging a solar panel.

The solar panel charging display device which is capable of achieving the object described above comprises: a solar panel transforming solar energy into electrical energy; a storage module connected to the solar panel for storing the electrical energy produced by the solar panel; a measurement module connected to the solar panel and the storage module for measuring an electrical signal which the solar panel transfers to the storage module; and a display module connected to the measurement module and dynamically displaying the voltage value or current value.

The present invention further provides a method of using the solar panel charging display device, which method comprises: providing a solar panel charging display device which comprises a solar panel, a storage module, a measurement module and a display module; the measurement module measuring the electrical signal transmitted to the storage module from the solar panel; and the display module dynamically displaying electrical signal get by the measurement module.

The present invention has the following advantages: the display module can dynamically display the electrical signal of energy in the storage module transported from the solar panel, thus the user can easily know the best positions or angles for arranging of the solar panel to achieve maximum electrical energy generation.

Further features and advantages of the invention will become apparent in detail from the ensuing description of exemplary embodiments of the socket structure, aided by the accompanying drawings.

### BRIEF DESCRIPTION OF THE DRAWINGS

FIG. 1 is a schematic diagram of the first embodiment of solar panel charging display device of the present invention.

FIG. 2 is a schematic diagram of the second embodiment of solar panel charging display device of the present invention.

FIG. 3 is a schematic diagram of the third embodiment of solar panel charging display device of the present invention.

FIG. 4 is a schematic diagram of the fourth embodiment of solar panel charging display device of the present invention.

FIG. 5 is a perspective view illustrating the use status of the solar panel charging display device of the present invention.

FIG. 6 is a perspective view illustrating the use status of the solar panel charging display device in the second embodiment of the present invention.

FIG. 7 is a flow chart illustrating the use method of the solar panel charging display device of the present invention.

In these figures:

10 solar panel

20 storage module

21 dissipative component

30 measurement module

31 resistor

32 operational amplifier (OP)

33 analog to digital converter (ADC)

40 display module

41 controller

42 lamp

43 monitor

44 sound output device

50 solar charger.

### DETAILED DESCRIPTION OF THE PREFERRED EMBODIMENT

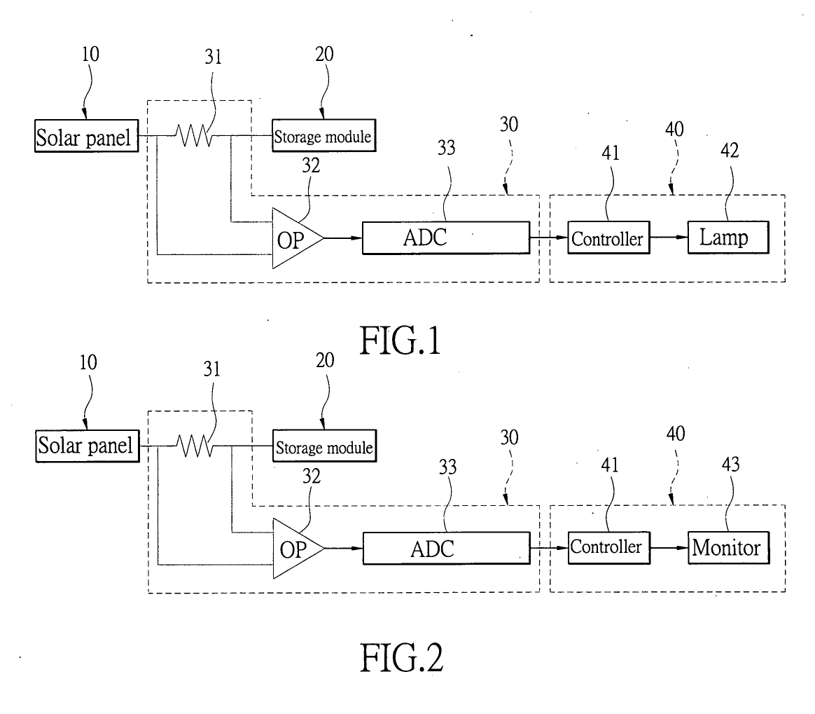

FIG. 1 shows a solar panel charging display device comprising a solar panel 10, a storage module 20, a measurement module 30 and a display module 40.

The solar panel 10 can transform solar radiation into electrical energy by amorphous silicon or poly crystalline. The higher intensity of illumination the solar panel 10 is received, the more electrical energy the panel will generate. The storage module 20 is connected to the solar panel 10; the electrical energy from the solar panel 10 will be transported to the storage module 20.

The measurement module 30 is connected between the solar panel 10 and storage module 20 for measuring the signal value of the electrical energy from the solar panel 10 to the storage module 20. The electrical signal value comprises voltage value or current value. In this embodiment, the signal value is a voltage value, which is converted into a current value.

The measurement module 30 comprises a resistor 31, an OP (Operational Amplifier) 32 and an ADC (analog to digital converter) 33. The resistor 31 is arranged between the solar panel 10 and storage module 20 and electrically connected with them. When the current generated by the solar panel 10 flows through the resistor 31, a voltage difference will be formed between the two ends of the resistor 31. Because the current generated by the solar panel 10 is low, the OP (Operational Amplifier) needs to be connected with the two ends of the resistor 31 for amplifying the voltage between the two ends of the resistor 31.

The amplified voltage value is an analog signal. For the sake of displaying on the display module 40, the analog signal must be converted into a digital signal. So the ADC 33 is connected to the rear end of the OP 32 to convert the analog signal 33 of the voltage into a digital signal. Then the digital signal is transported to the display module 40.

The main object of setting the display module 40 is to dynamically display the voltage value measured by the measurement module 30. In this embodiment, the display module 40 comprises a controller 41 and a lamp 42, wherein the controller 41 is connected to the rear end of ADC 33 for receiving the digital signal of the voltage value. The controller 41 can adjust the flash frequency of the lamp 42 according to the voltage value, the higher voltage, the rapider flash frequency. In another way, a logic circuit can be set in the controller 41, in which the voltage value is divided by the resistance of the resistor 31 to calculate the current value flowing through the resistor 31 to adjust the flash frequency of the lamp 42 according to the current value.

The present invention has the following advantages: the flash frequency of the lamp 42 of the display module 40 can be adjusted according to the signal value of the electrical energy generated by the solar panel 10. So the users can easily know the relation between the solar panel 10's positions or angles and the electrical energy the solar panel 10 generated, then an optimal position or angle for getting maximum energy of the solar panel 10 will be get.

Referring to FIG. 2, it shows the second embodiment of the present invention, the difference between this embodiment and the first embodiment is that the display module 40 comprises a controller 41 and a monitor 43. The value displaying on the monitor 43 can be dynamically adjusted by the controller 41 according to the digital signal of the voltage value got by the measurement module 30. The controller 41 can also convert the voltage value into current value of the resistor 31, then the value displaying on the monitor 43 will be adjusted according to the current value.

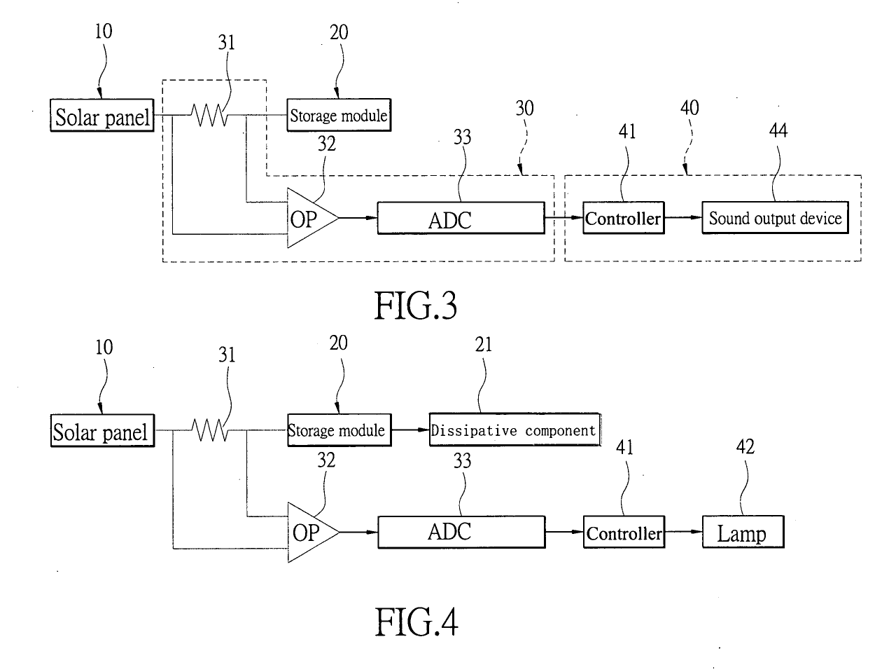

Referring to FIG. 3, it shows the third embodiment of the present invention, the difference between this embodiment and the first embodiment is that the display module 40 comprises a controller 41 and a sound output device 44. The sound output frequency of the sound output device 44 can be adjusted by the controller 41 according to the voltage of the measurement module 30, the higher voltage, the higher sound output frequency. The controller 41 can also convert the voltage into current value of the resistor 31. The sound output frequency of the sound output device 44 can be adjusted according to the current value.

The abovementioned second embodiment and third embodiment have the same effect on the first embodiment: the display module 40 can dynamically display the information for the users by images or different sound according to the different energy the solar panel 10 generated. So that the users will know the relation between the solar panel 10 positions or angles and the electrical energy generated by the solar panel 10 to get an optimal position or angle for getting maximum energy of the solar panel 10.

Referring to FIG. 4, it shows the fourth embodiment of the present invention. When the storage module 20 is fully charged, the storage module 20 can not be charged by the solar panel 10, and then the measurement module 30 can not measure any electrical signal. In this status, the users may mistake that some problems have happened to the solar panel 10, or that the solar panel 10 has no enough radiation. But actually, the solar panel 10 still can supply energy normally.

To solve this problem, and to let the solar panel charging display device can be operated normally, in the fourth embodiment, the storage module 20 is connected to a dissipative component 21. When the storage module 20 is fully charged, a portion of the energy in the storage module 20 will be consumed by the dissipative component 21, and thus the storage module 20 will not be fully discharged. In this way, the storage module 20 can be charged by the solar panel 10 all the time and the measurement module 30 can measure the electrical signal all the time. Accordingly, the display module 40 can display how much energy has been generated by the solar panel 10 all the time.

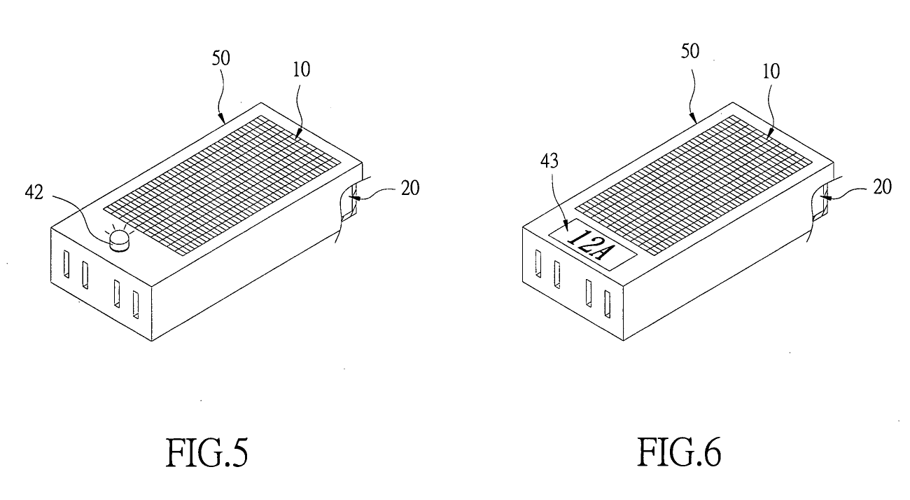

Referring to FIG. 5 and FIG. 6, it shows the first embodiment and second embodiment of the invention applied in a solar charger 50. The users can know the energy-generating ability of the solar charger 50 by the lamp 42 or monitor 43, then the users can move the solar charger 50 till the lamp reaches the highest flash frequency or the maximum value displayed in the monitor 43.

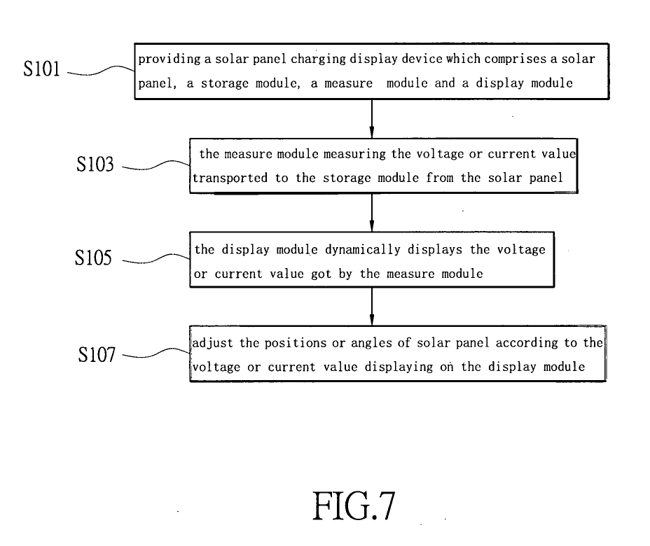

Referring to FIG. 7, also referring to FIG. 1 to FIG. 3, the use method of the abovementioned solar charging display device can be included into the following steps:

S101: Providing a solar panel charging display device which comprises a solar panel 10, a storage module 20, a measurement module 30 and a display module 40; when solar radiation received, the solar panel 10 will generate electrical energy and transport the energy to the storage module 20.

S103: The measurement module 30 measuring the electrical signal (voltage or current value) transported to the storage module 20 from the solar panel 10;

S105: the display module 40 dynamically displaying electrical signal got by the measurement module 30, herein the display module 40 can display the electrical signal by the flash frequency of the lamp 42, or value on the monitor 43, or sound output frequency of the sound output device 44.

S107: adjusting the solar panel positions or angles according to the voltage or current value displaying on the display module 40 to get an optimal position or angle for the solar panel 10 to generate maximum energy.

Although the invention herein has been described with reference to particular embodiment, it is to be understood that these embodiments are merely illustrate of the principles and applications of the present invention, it is therefore to be understood that numerous modifications may be devised without departing from the spirit and scope of the present invention as defined by the appended claims.

What is claimed is:

1. A solar panel charging display device comprising:
a solar panel capable of transforming solar energy into electrical energy;
a storage module connected to the solar panel and capable of storing the electrical energy produced by the solar panel;
a measurement module connected to the solar panel and the storage module, capable of detecting an electrical signal which indicates the level of energy being transferred from the solar panel into the storage module; and
a display module connected to the measurement module and dynamically displaying the electrical signal detected by the measurement module.

2. The solar panel charging display device according to claim 1, wherein said electrical signal is a voltage value.

3. The solar panel charging display device according to claim 2, wherein said measurement module comprises a resistor arranged between said solar panel and said storage module, the measurement module measures the voltage value difference between the two ends of the resistor when a current generated by the solar panel flows through the resistor.

4. The solar panel charging display device according to claim 3, wherein said measurement module further comprises an operational amplifier and an analog-to-digital converter, wherein said operational amplifier is connected to two ends of said resistor for amplifying the voltage value, wherein said analog-to-digital converter is connected to said operational amplifier to convert the analog signal of the voltage into a digital signal.

5. The solar panel charging display device according to claim 4, wherein said display module comprises a controller and a lamp, wherein said controller is connected to said analog-to-digital converter and adjusts the flash frequency of the lamp according to the voltage value.

6. The solar panel charging display device according to claim 5, wherein said flash frequency of the lamp is proportional to the voltage value.

7. The solar panel charging display device according to claim 5, wherein said controller converts the voltage value into a current value and adjusts the flash frequency of the lamp according to the current value, wherein said flash frequency of the lamp is proportional to the current value.

8. The solar panel charging display device according to claim 4, wherein said display module comprises a controller and a monitor, and the controller is connected to the analog-to-digital converter and adjusts the value displaying on the monitor according to the digital signal of the voltage value.

9. The solar panel charging display device according to claim 8, wherein said controller converts the voltage value into a current value, and adjusts the value displaying on the monitor according to the current value.

10. The solar panel charging display device according to claim 4, wherein the display module comprises a controller and a sound output device, said sound output device is connected to the analog-to-digital converter, and a sound output frequency of the sound output device is adjusted by the controller according to the voltage value.

11. The solar panel charging display device according to claim 10, wherein the sound output frequency of the sound output device is proportional to the voltage value.

12. The solar panel charging display device according to claim 10, wherein said controller converts the voltage value to the current value and adjusts sound output frequency of the sound output device according to the current value, wherein said sound output frequency of the sound output device is proportional to the current value.

13. The solar panel charging display device according to claim 1, wherein the electrical signal is current.

14. The solar panel charging display device according to claim 1, wherein the storage module comprises a dissipative component for consuming the energy stored in the storage module.

15. A method of using a solar panel charging display device, which method comprises the steps of:
(a) providing a solar panel charging display device which comprises a solar panel, a storage module, a measurement module and a display module;
(b) measuring with the measurement module the electrical signal transported to the storage module from the solar panel; and
(c) dynamically displaying on the display module an electrical signal generated by the measurement module.

16. The method according to claim 15 further comprising step (d) adjusting the positions or angles of the solar panel according the electrical signal displayed on the display module.

17. The method of using a solar panel charging display device according to claim 15, wherein said display module comprises a lamp, and the flash frequency of the lamp is proportional to the electrical signal measured by the measurement module.

18. The method of using a solar panel charging display device according to claim 15, wherein said display module further comprises a monitor which displays the electrical signal measured by the measurement module.

19. The method of using a solar panel charging display device according to claim 15, wherein said display module comprises a sound output device, and the sound output frequency of the sound output device is proportional to the electrical signal measured by the measurement module.

20. The method of using a solar panel charging display device according to claim 15, wherein the electrical signal is a voltage value of a current value.
